(19) United States
(12) Patent Application Publication
(10) Pub. No.: US 2005/0233471 A1
(43) Pub. Date: Oct. 20, 2005

(54) Method of assaying the antioxidant activity of pure compounds, extracts and biological fluids

(75) Inventors: Murray James McEwan, Westmoreland, Christchurch (NZ); Somasuntharam Tharmalingam Senthilmohan, St. Albans, Christchurch (NZ)

Correspondence Address: STEPTOE & JOHNSON LLP, 1330 CONNECTICUT AVENUE, N.W., WASHINGTON, DC, 20036, US

(73) Assignee: Syft Technologies Limited, Middleton, Chrischurch (NZ)

(21) Appl. No.: 10/520,074

(22) PCT Filed: Jul. 4, 2003
(86) PCT No.: PCT/NZ03/00141

§ 371 Date: Jun. 22, 2005

(30) Foreign Application Priority Data
Jul. 5, 2002 (NZ) 520019

(51) Int. Cl. G01N 24/00

(52) U.S. Cl. 436/173; 436/6

(57) ABSTRACT

A direct comparisons of the antioxidant activities of various pure compounds (eg., Trolox®(6-hydroxy-2,5,7,8-tetramethylchroman-2-carboxylic acid), extracts and biological fluids (eg. human plasma) can be effected by means of standardisable, objective method of determining and measuring the antioxidative and oxidative radical scavenging activities of a natural or synthetic substance, including the measurement of an indicator reaction product gas, ethylene, in the reaction headspace using Selective Ion Flow Tube Mass Spectrometry (SIFT-MS). This method assays ethylene liberated from α-keto-γ-methiolbutyric acid (KMBA) on reaction with peroxy radicals, other radicals or other reactive oxygen species that can oxidise KMBA to ethylene. From the production rate and concentration of the ethylene, the total antioxidant activity of an added analyte in question and its rate of reaction with oxidative free radicals may be determined.

### TECHNICAL FIELD

The present invention relates to a novel method of ethylene analysis for assaying the antioxidant activity of pure compounds, extracts and biological fluids using Selective Ion Flow Tube Mass Spectrometry (SIFT-MS). SIFT-MS technology allows the real time measurement of trace gases generally to a few parts per billion detection limit in complex mixtures such as breath or the headspaces above samples of urine or blood. To use such technology, a small amount of sample gas is introduced into a stream of helium and H₃O, NO⁺ or O₂⁺ precursor ions before electronic separation. Mass and absolute concentration analysis of each constituent is completed and displayed within seconds. The freedom from electron bombardment, magnetic separation and complex sample preparation such as used in gas chromatography and conventional mass spectrometry by the use of the technology of the present invention will allow rapid, uncomplicated, inexpensive, accurate, multiple analyte resolution.

### BACKGROUND ART

The formation of reactive oxygen species in aerobic organisms is an unavoidable consequence of the coupling of oxidative phosphorylation of ADP with the reduction of molecular oxygen by four electrons to water. Other sources of oxidative radicals include miccrosomal and photosynthetic electron transport chains, active phagocytosis, and the activity of a variety of enzymes that produce different reactive species as intermediates.

The in vivo generation of oxidative free radicals results in the chemical degradation of cellular organelles, membranes, deoxyribosenucleic acids (DNA), and other structural elements as well as the disruption of biochemical pathways, transduction and translation events as well as genetic replication and repair. These effects may be translated into tissue, and organ damage and malfunction leading to a wide variety of diseases and the generation of malignancies. These damaging changes may be produced in various tissues by trauma, environmental hazards, metabolic defects, inflammation or infections as well as the natural responses to cellular aging, or natural and acquired immunity to foods, commensal microorganisms, environmental agents or surveillance against spontaneously occurring tumourogenesis. Natural or synthetic dietary or parenterally administered agents capable of reducing or eliminating oxidative free radicals in cells and tissues are currently thought to protect against actual or potential oxidative damage in vivo.

The measurement of free radical generation and oxidation as well as oxidative radical scavenging by naturally occurring or extraneous molecules is currently both complex and time consuming. This measurement is made possible by the application of SIFT-MS technology to provide a rapid, continuous, sensitive means of measuring oxidative free radical and scavenging activities without calibration, standards or complex sample preparation.

The application of the SIFT-MS technology enables measuring the biochemical production of oxidative free radicals in vivo or in vitro to the capacity of oxidative radical scavengers to impede, inhibit or compete with the generation or activity of oxidative free radicals. Consequently analytical system utilising SIFT-MS technology can be used to calibrate and standardise other in vitro measurement techniques, monitor and quantify oxidative chemical generation and reactivity, monitor and quantify antioxidant generation and reactivity and determine the relative rates of the generation and the relative reactivities of those systems.

Cells have evolved oxidative defences that involve specially adapted enzymes as well as membrane-associated and aqueous phase molecules. The production of reactive oxygen species in vivo does not necessarily imply cellular damage but oxidative stress is thought to occur when the production of those oxidative radicals exceeds the scavenging, protective capacity of the endogenous antioxidants.

In vitro assays of oxidative free radical activity based on the time required to obtain maximum oxygen consumption have been described. Wayner et al “Quantitative measurement of the total, peroxyl radical-trapping antioxidant capability of human blood plasma by controlled peroxidation”. FEBS Lett. 1985;187;33-37), “phycoerythrin emission fluorescence”. Glazer A N. “Fluorescence-based assay for reactive oxygen species: A protective role for carnitine”. FASEB J. 1988;2:2487-91) and peroxyl radical oxidation of α--keto-γ-methiolbutyric acid (KMBA) to ethylene by gas chromatograhy (Weston G W, et al. A rapid gas chromatographic assay for determining oxyradical scavenging capacity of antioxidants and biological fluids. Free Radical Biology & Medicine 1998;24:480-93)

The method of the present invention is based on the known partial inhibition of ethylene formation in the presence of antioxidants that compete with KMBA for oxyradicals. This has been measured previously in the headspace of a reaction vessel by gas chromatography to derive the Total Oxyradical Scavenging Capacity Assay (TOSCA).

### OBJECT OF THE INVENTION

An object of the present invention is to measure the concentration of ethylene as an assay for antioxidant activity using SIFT-MS technology.

### DISCLOSURE OF THE INVENTION

In one form the invention is a method of determining, measuring and comparing the oxidative radical activity in a natural or synthetic substance including the measuring by SIFT-MS technology of the oxidative free radical and scavenging activities in a gas sample taken from the headspace of the substance to be measured, comprising measuring the concentration of ethylene as an assay for antioxidant activity to provide a measurement of the concentration of the analyte to thereby indicate the total activity of an antioxidant and the rate of reaction of the antioxidant with the substrate, the method comprising
producing, mass selecting and accelerating precursor ions into a stream of inert carrier gas,
injecting a mixture of the gas sample and the analyte into the carrier gas/ion stream,
allowing the ethylene in the reaction mixture head space to react with the selected precursor ions,
detecting, amplifying and analysing the amount and rate of ethylene produced in the reaction mixture headspace as a measure of the rate and amount of introduced analyte antioxidant activity.

Preferably the trace elements in the gas sample react with the precursor ions in the helium stream.

Preferably the partial pressure of ethylene in the gas sample is calculated as part of the measurement of the rate and amount of introduced analyte.

Preferably the gas sample is introduced into the carrier gas/ion stream at a calibrated rate via a heated capillary inlet.

Preferably the concentration of each gas species of volatile organic compounds in the gas mixture is calculated from the number densities of the precursor and product ions.

Preferably the number densities are measured by a second mass filter in conjunction with a particle multiplier and a software interface.

### BRIEF DESCRIPTION OF THE DRAWINGS

FIG. 1 is a graph of the rate of reaction of KMBA oxidation by peroxyl radicals in the presence of increasing concentrations of trolox acid.

FIG. 2 is a graph of the rate of reaction of KMBA oxidation by peroxyl radicals in the presence of increasing concentrations of ascorbic acid.

FIG. 3 is a graph of the rate of reaction of KMBA oxidation by peroxyl radicals in the presence of increasing concentrations of uric acid.

FIG. 4 is a graph of the rate of reaction of KMBA oxidation by peroxyl radicals in the presence of increasing concentrations of glutathione (GSH) acid.

FIG. 5 is a graph of the reaction rate of KMBA oxidation by peroxy radicals in the presence of increasing amounts of human plasma.

FIG. 6 is a graph of the regression of TOSC values of trolox acid at different concentrations.

FIG. 7 is a graph of the regression of TOSC values of ascorbic acid at different concentrations.

FIG. 8 is a graph of the regression of TOSC values of glutathione (GSH) acid at different concentrations.

FIG. 9 is a graph of the regression of TOSC values of uric acid at different concentrations.

FIG. 10 is a graph of the regression of TOSC values of human plasma at different concentrations.

### DESCRIPTION OF PREFERRED EMBODIMENTS OF THE INVENTION

In a highly preferred form, peroxyl radicals were generated by the thermal homolysis of AAPH (2,2′-Azobis(2-amidinopropane)dihydrochloride) at 35° C. and at temperatures between 35° C.-39° C. An assay was carried out using 0.2 mM of substrate KMBA and 20 mM of AAPH in 100 mM of phosphate buffer at pH 7.4. The technique may be extended to other radicals such as hydroxy, OH and alkoxy and other reactive oxygen species such as HOCl and ONOO— that can oxidise KMBA to ethylene.

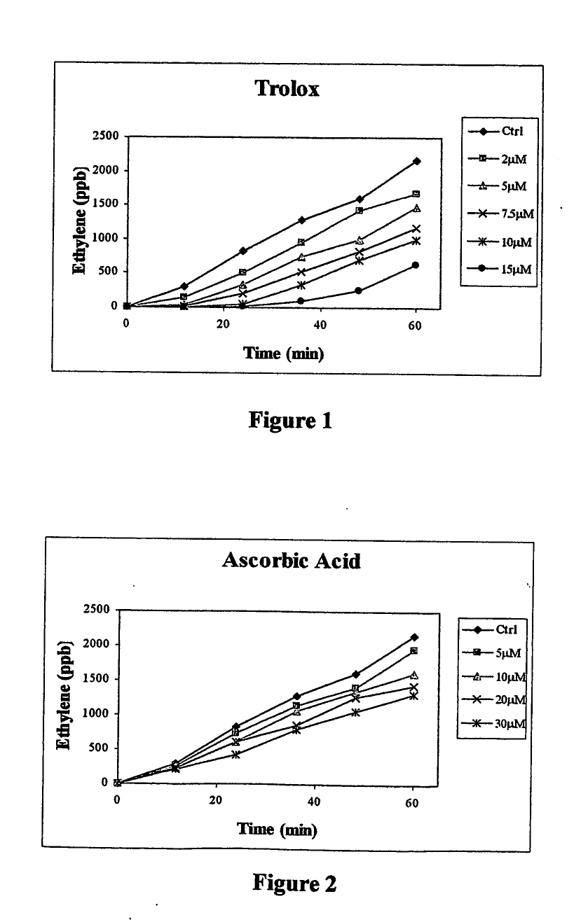

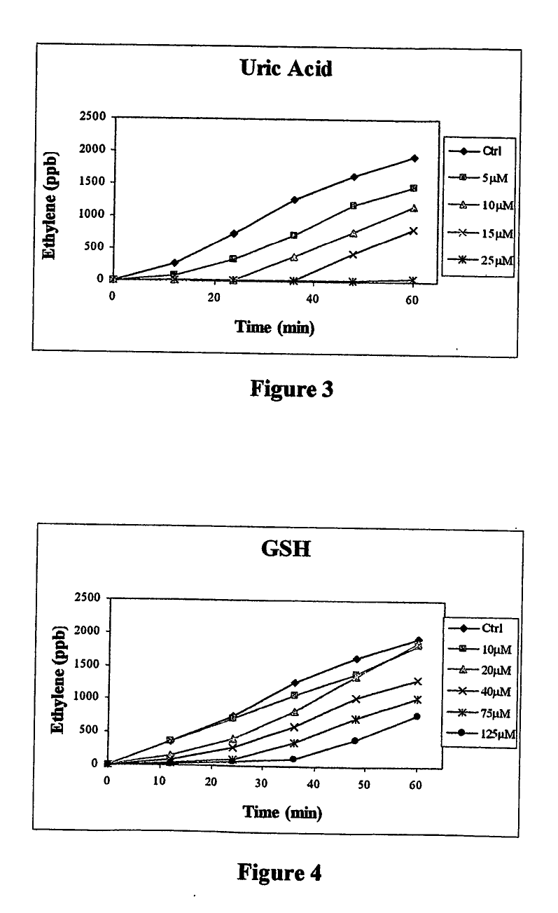

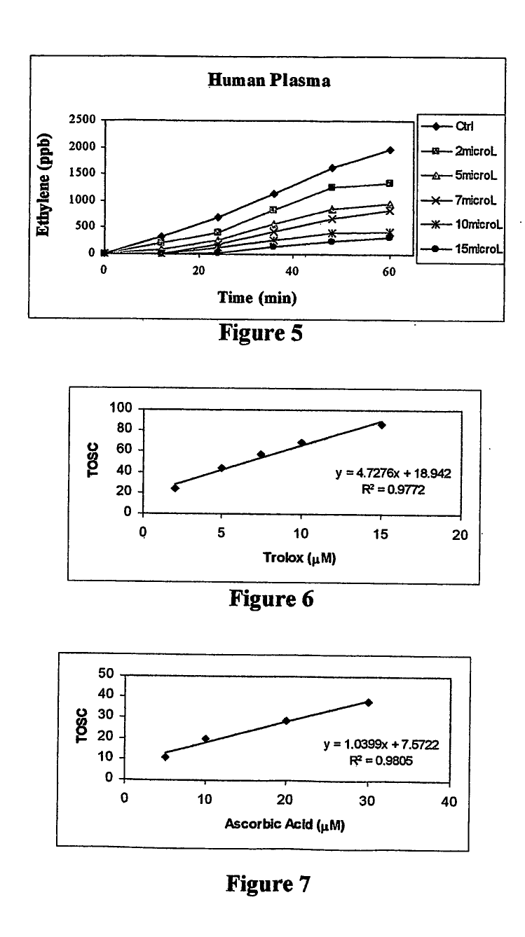

The TOSC values were measured for different concentrations of antioxidants, trolox, ascorbic acid, glutathione, uric acid and human plasma and are obtained from growth curves of ethylene production with time. These curves are shown in FIGS. 1 through 5 for the stated antioxidant at varying concentrations. The area under each of these growth curves is found for each concentration of the specified antioxidant. The ratio of this area, ∫SA, to the area under the control curve, ∫CA, provides the measure of the TOSCA according to
TOSCA=100-(∫SA/∫CA)×100

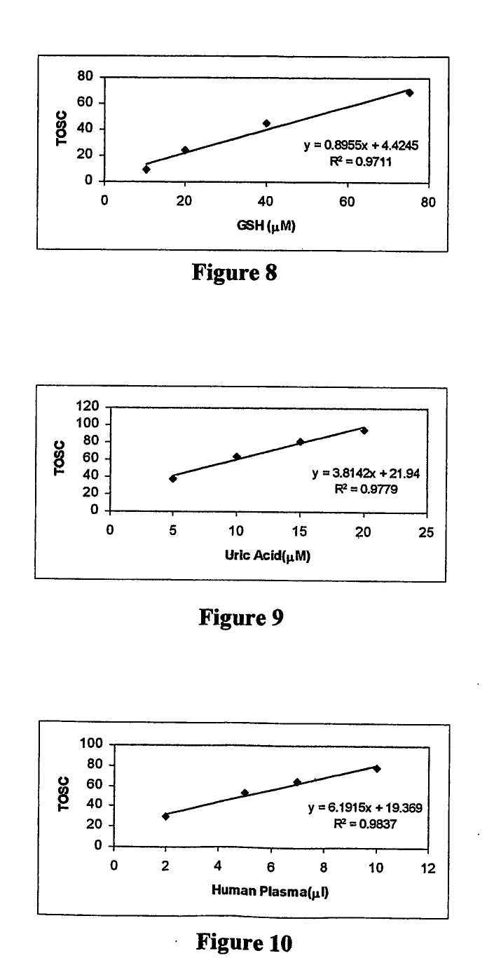

The linear TOSC relationships with concentration derived by this method for each of the antioxidants are shown in FIGS. 6 through 10.

Modifications of the SIFT-MS technique for analyzing trace components of gas mixtures have been described by Milligan D B, Wilson P F, Mautner M N, Freeman C G, McEwan M J, Clough T J, Sherlock R R. Real-Time, High-Resolution Quantitative Measurement of Multiple Soil Gas Emissions: Selected Ion Flow Tube Mass Spectrometry. J. Environ. Qual. 2002 31: 515-524. SIFT-MS measures trace gases in complex mixtures such as air, breath and the headspace above liquids, allowing the analysis of a single exhalation of breath in real time, giving immediate results without the need for pre-concentration of the volatile gas compounds or calibration using standards.

SIFT-MS utilizes selective chemical ionization, using precursor ions generated by electron impact, by microwave discharge or by glow discharge. The precursor ions are mass selected using a quadrupole mass filter to inject mass selected precursor ions into a stream of helium carrier gas and allowed to reach thermal equilibrium. Positive or negative precursor ions may be chosen. The precursor ion must be unreactive with the bulk gas within which the trace species is carried, but react rapidly with the trace species of interest. O₂⁺ ions are used to measure ethylene in this assay. The reaction vessel headspace sample is introduced into the carrier gas stream at a calibrated rate via a heated capillary inlet, alternatively a mass flow controller or calibrated leak valve could be used. Following this, the trace components within the sample gas mixture undergo reaction with the precursor ions in the helium bath gas. The concentration of a (or each) trace species VOC in the gas mixture is then calculated from the observed number densities of the precursor and product ions as measured by a second mass filter (quadrupole or time-of-flight mass spectrometer) in conjunction with a particle multiplier and specialized software interface, library and data processor/analyser. In order to calculate the actual partial pressure of the trace species it is essential to know the rate of and products formed by the reaction of the precursor ion with the trace neutral under the conditions within the flow tube.

This SIFT-MS analysis of ethylene generated by the peroxy radical reactivity with KMBA is performed in real time, with no sample preparation, no calibration and without standards. In one preferred embodiment of the invention the assay provides an in-vitro method for the sensitive, rapid and continuous, real time, absolute concentration determination and quantification of oxidative radical activity of pure compounds, extracts and biological fluids as well as the antioxidant activity of pure compounds, extracts and biological fluids. The method may also be used for in-vivo measurement of antioxidant activity.

In the present invention the reaction between O₂⁺ and ethylene that is measured is as follows.
O₂⁺+C₂H₄→C₂H₄⁺O₂ k=1.0×10⁻⁹ cm³ molecule⁻¹ s⁻¹

The precursor and product ions are scanned over predetermined ranges of mass-to-charge ratio, m/z, for a given time. For this invention, the downstream analytical mass filter was switched between the m/z value of the precursor ion (m/z 32) and the m/z value of C₂H₄⁺ (m/z 28) ethylene to target the chosen oxyradical/KMBA end product trace gas species. The partial pressure of ethylene in the sample is then calculated immediately, on line, from the precursor and product ion count rates. In this way, rapid changes in ethylene concentrations are monitored by SIFT-MS in sequentially obtained headspaces during, or at the end of the oxidative reaction.

The invention provides a SIFT-MS method for the determination, measurement and comparison of oxidative radical activity activity in vitro and in vivo in both natural and synthetic, substances using any oxidant or antioxidant. The SIFT-MS method may be automated to determine and measure oxidative radical activity and antioxidant activity in any natural and/or synthetic substances.

The following table demonstrates the linear correlation between the different assays and sample concentration.

| | TOSCA-SIFT | TOSCA-GC | ORAC |
|---|---|---|---|
| Trolox (μM) | 2-15 | 2-20 | 0-3 |
| Uric Acid (μM) | 5-20 | 2-25 | 0-4 |
| Ascorbic Acid (μM) | 5-30 | 5-50 | 0-2 |
| GSH (μM) | 10-75 | 10-75 | — |

In the above table:
SIFT = selected ion flow tube-mass spectrometry TOSC measurement
GC = gas chromatography TOSC measurement(Winston et al 1998)
ORAC = oxygen radical absorbance capacity TOSC measurement(Cao G, Alessio HM, Cutler RG. Oxygen radical absorbance capacity assay for antioxidants. Free Radic. Biol Med. 1993; 14: 303-11)

The following table is a comparison of relative total oxyradical scavenging capacity (TOSC) values (on a per unit concentration basis) of different antioxidants calculated from the TOSCA-SIFT-MS and other methods; TOSCA, ORAC, TRAP-1 (phycoerythrin) (Ghiselli, A.; Serafini, M.; Maiani, G.; Azzini, E.; Ferno-Luzzi, A. A. Free Radical Biol. Med. 18: 29-36,1995) and TRAP-2 (oxygen electrode). (Wayner, D. D. M.; Burton, G. W.; Ingold, K. U.; Barclay, L. R. C.; Locke, S. J. Biochem. Biophys. Acta., 924:408-419,1996.). TRAP stands for Total peroxy radical-trapping antioxidant activity.

| | SIFT-MS | TOSCA | ORAC | TRAP-1 | TRAP-2 |
|---|---|---|---|---|---|
| Trolox | 1 | 1 | 1 | 1 | 1 |
| Ascorbic acid | 0.36 | 0.46 | 0.52 | 0.75 | 0.85 |
| GSH | 0.22 | 0.19 | — | — | 0.18 |
| Uric acid | 1.08 | 0.70 | 0.92 | 0.85 | 0.65 |

The following table is a comparison of relative total oxyradical scavenging capacity (TOSC) values (on a per unit weight basis) of different antioxidants calculated from the TOSCA-SIFT-MS and the other methods of TOSCA and ORAC.

| | SIFT-MS | TOSCA | ORAC |
|---|---|---|---|
| Trolox | 1 | 1 | 1 |
| Ascorbic acid | 0.36 | 0.69 | 0.67 |
| GSH | 0.19 | 0.16 | — |
| Uric acid | 1.18 | 0.95 | 1.44 |

By reason of the present invention, no actual sampling of the substance to be measured is required since the analysis is taken from a headspace of the sample. The method also allows automation of the process and is capable of measuring absolute concentrations and is therefore suitable also for serum and biological fluids.

Having described preferred embodiments of the invention it will be apparent to those skilled in the art that various changes and ablations can be made to the embodiments and yet still come within the general concept of the invention. All such changes and alterations are intended to be included in the scope of this specification.

1 A method of determining, measuring and comparing the oxidative radical activity in a natural or synthetic substance including the measuring by SIFT-MS technology of the oxidative free radical and scavenging activities in a gas sample taken from the headspace of the substance to be measured, comprising measuring the concentration of ethylene as an assay for antioxidant activity to provide a measurement of the concentration of the analyte to thereby indicate the total activity of an antioxidant and the rate of reaction of the antioxidant with the substrate, the method comprising
producing, mass selecting and accelerating precursor ions into a stream of inert carrier gas,
injecting a mixture of the gas sample and the analyte into the carrier gas/ion stream,
allowing the ethylene in the reaction mixture head space to react with the selected precursor ions,
detecting, amplifying and analysing the amount and rate of ethylene produced in the reaction mixture headspace as a measure of the rate and amount of introduced analyte antioxidant activity.

2. The method as claimed in claim 1, wherein the trace elements in the gas sample react with the precursor ions in the helium stream.

3. The method as claimed in claim 1, wherein the partial pressure of ethylene in the gas sample is calculated as part of the measurement of the rate and amount of introduced analyte.

4. The method as claimed in claim 1, wherein the gas sample is introduced into the carrier gas/ion stream at a calibrated rate via a heated capillary inlet.

5. The method as claimed in claim 1, wherein the concentration of each gas species of volatile organic compounds in the gas mixture is calculated from the number densities of the precursor and product ions.

6. The method of claim 6, wherein the number densities are measured by a second mass filter in conjunction with a particle multiplier and a software interface.
